(19) United States
(12) Patent Application Publication
(10) Pub. No.: US 2024/0026839 A1
(43) Pub. Date: Jan. 25, 2024

(54) Pulse Detonation Wave Generator

(71) Applicant: Alden David Meier, Mt. Juliet, TN (US)

(72) Inventor: Alden David Meier, Mt. Juliet, TN (US)

(21) Appl. No.: 18/377,032

(22) Filed: Oct. 5, 2023

Related U.S. Application Data
(63) Continuation-in-part of application No. 17/828,664, filed on May 31, 2022, now abandoned.
(60) Provisional application No. 63/195,090, filed on May 31, 2021.

(51) Int. Cl. F02K 7/06

(52) U.S. Cl. CPC F02K 7/06; F05D 2260/20

(57) ABSTRACT

A device and assembly for reliably generating supersonic detonation waves in a fuel and air or fuel and oxygen mixture. The device may use a hemispherical detonation chamber into which reactants, comprising a fuel and air or oxygen mixture are injected and ignited by a laser igniter to initiate a detonation wave. The wave is reflected by the hemispherical geometry of the detonation chamber and may exit the device through a fast-acting valve. The detonation chamber may be then purged and the cycle is repeated many times per second. The device may be used for various applications which include but are not limited to a stand-alone intermittent combustion engine, a pre-detonator for an intermittent combustion engine, a projectile launcher, a cleaning device, acoustical energy generation, pressure energy generation, various manufacturing processes and electric power generation. The device may use liquid, gaseous, or solid fuels, depending on the application.

### FIELD OF THE INVENTION

The present invention is in the field of combustion energy generation and, more specifically, pulse detonation combustion.

### BACKGROUND OF THE INVENTION

The current approach for generating a pulse detonation wave in a Pulse Detonation Engine (PDE) or other device is to initiate deflagration in the main combustion tube itself or a pre-detonation chamber and then, by various means, transition the deflagration into a detonation wave in the main combustion tube. This is known as deflagration-to-detonation transition (DDT). This typically results in a relatively long combustion tube which is necessary in order to transition the deflagration wave to detonation and often requires additional turbulence generating techniques such as the Shchelkin spiral to accelerate and facilitate the transition from deflagration to detonation. Due to the relatively long combustion tube required in this approach, heating in the long tube becomes a major obstacle to a practical Pulse Detonation Engine (PDE) or Pulse Detonation Rocket Engine (PDRE). In addition, the long combustion tube reduces the operating frequency of the device. Another disadvantage of this approach is the inconsistency in reliably achieving detonation in the main chamber with some deflagrations failing to transition to detonation. This has a significant impact on the operation of the engine.

Techniques have been developed to implement a pre-detonator which initiates the deflagration prior to the main detonation in the combustion tube. These pre-detonators allow a smaller shock wave to be created which then initiates detonation in the main combustion tube but the current approaches also suffer from failures to transition from deflagration to detonation.

All of the prior art has mainly been focused on improving the transition time and the reliability of the deflagration-to-detonation transition. This has resulted in many different techniques to facilitate the transition including Shchelkin spirals, wire rings, orifice plates, center bodies or nozzles. While many of these techniques do accelerate the transition, they introduce complexity into the device, result in severe heating and reduce the operational reliability of the device.

The major challenges to achieve operational Pulse Detonation Propulsion systems are: (a) The ability to rapidly and reliably initiate detonations using practical fuels; (b) Managing heat loads in long combustion tubes; (c) Operating at very high frequencies; and (d) Minimizing weight, length and overall volume.

### BRIEF SUMMARY OF THE INVENTION

An object of some embodiments of the present invention is to rapidly and reliably generate pulsed supersonic shock waves under a wide variety of conditions.

Another object of some embodiments of the present invention is to use a laser igniter to rapidly deliver a large amount of energy into the reactants to initiate detonation at a very precise location.

Another object of some embodiments of the present invention is to allow a variety of practical fuels and oxidizers to be used, depending on the application. The device may use liquid, gaseous, or solid fuels or a combination thereof, providing a wide range of options specifically tailored to the operational requirements.

Another object of some embodiments of the present invention is to provide a device that can operate at high frequencies.

Another object of some embodiments of the present invention is to minimize the volume and specifically, the length of the device.

Another objective of some embodiments of the present invention is to eliminate the need for turbulence generating techniques such as Shchelkin spirals to accelerate and facilitate the transition from deflagration to detonation.

Another objective of some embodiments of the present invention is to provide a device that may be used repeatedly (i.e., in sustained operation), such as to power an aircraft.

In some embodiments, the present invention achieves these objectives by reducing the size of the detonation wave generator into a device that is as small as possible using a hemispherical detonation chamber that reflects and concentrates the detonation wave. The device can be used as a stand-alone combustor, or as a pre-detonator for a larger combustor or as a pulse detonation generator for other uses. Some applications include use in pulse detonation rocket engines or air-breathing pulse detonation engines as well as for any other application that requires a supersonic detonation wave. For example the device can be used for various other applications not related to propulsion, including but not limited to electric power generation, a projectile launcher, a cleaning device for industrial equipment, acoustical energy generation, pressure energy generation and various manufacturing processes.

### BRIEF DESCRIPTION OF THE DRAWINGS

FIG. 1 shows a cross-sectional view of one embodiment of the pulse detonation wave generator.

FIG. 2 shows a top view of the embodiment of the pulse detonation wave generator depicted in FIG. 1.

FIG. 3 shows a cross sectional view of a valveless embodiment of the pulse detonation wave generator.

FIG. 4A shows the principle of operation where a detonation wave is initiated and propagates outward from the ignition origin.

FIG. 4B shows the principle of operation where the detonation wave is reflected off the hemispherical detonation chamber and exits the chamber.

FIG. 5 shows a schematic of the full detonation cycle.

FIG. 6 shows a top perspective view of a pulse detonation wave generator of another embodiment of the present invention.

FIG. 7 shows a bottom perspective view of the pulse detonation wave generator of FIG. 6.

FIG. 8 shows a side perspective view of the pulse detonation wave generator of FIG. 6.

FIG. 9 shows a top plan view of the pulse detonation wave generator of FIG. 6.

FIG. 10 shows a bottom plan view of the pulse detonation wave generator of FIG. 6.

FIG. 11 shows a sectional view of the pulse detonation wave generator of FIG. 9 taken along line 11-11 of FIG. 9.

FIG. 12 shows a perspective sectional view of the pulse detonation wave generator of FIG. 9 taken along line 11-11 of FIG. 9.

### DETAILED DESCRIPTION

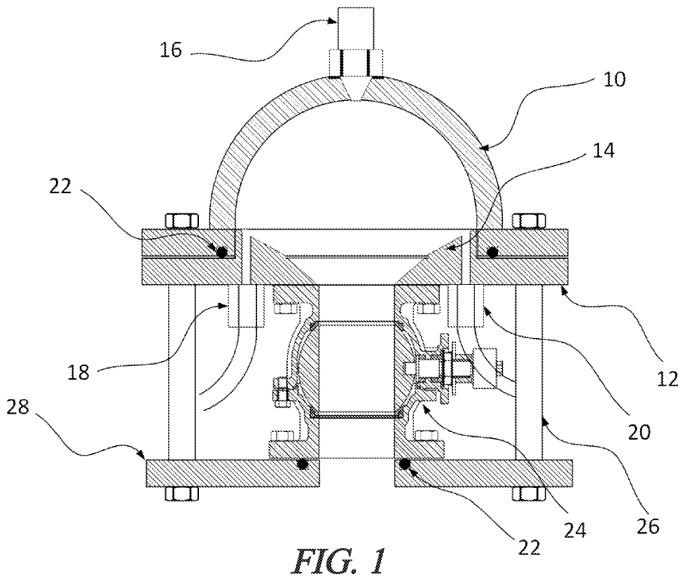

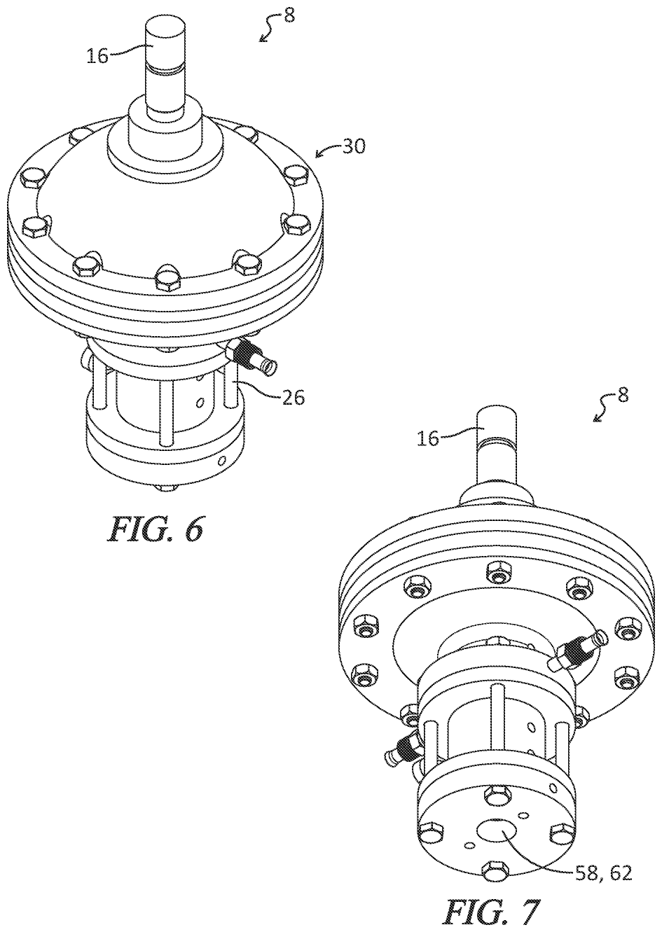

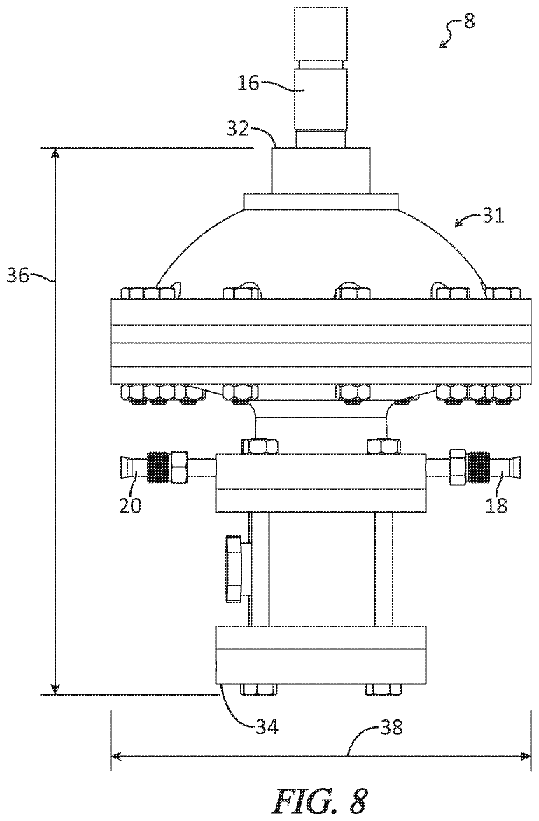

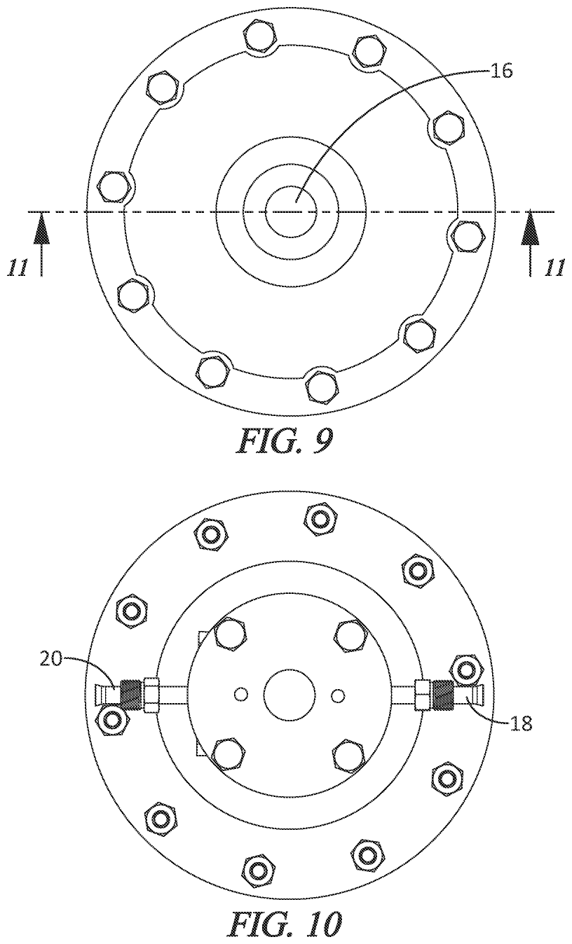

FIGS. 1-12 show various embodiments of a pulse detonation wave generator designated by the numeral 8. In the drawings, not all reference numbers are included in each of the drawings for the sake of clarity. FIGS. 1-12 are drawn generally to scale, however, it will be appreciated that other dimensions are possible.

Referring further to FIGS. 1-12, the pulse detonation wave generator 8 may comprise a housing having a proximal end 32, a distal end 34, a length 36 extending from the proximal end to the distal end, a width 38 perpendicular to the length and an interior 40.

The interior may include a round, hemispherical detonation chamber 10. The distal end of the hemispherical detonation chamber 10 may be closed off with a base plate 12 which has an exit aperture 52 and which may be attached to the hemispherical detonation chamber 10 with a flange and bolts. Alternatively, a v-band clamp can be used to connect the base plate 12 to the hemispherical detonation chamber 10. An O-ring 22 may provide a gas seal between the hemispherical detonation chamber 10 and the base plate 12. In an alternate embodiment, a high temperature crush gasket, such as a mica gasket can be used to ensure a gas seal. Mica provides an effective seal at very high temperatures.

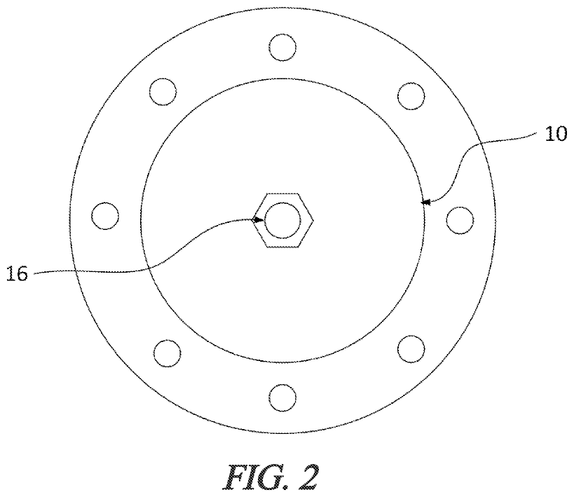

In the illustrated embodiments of FIGS. 1-12, a hemispherical wall 42 located in the housing interior forms the proximal end of the detonation chamber 10. In addition, in the illustrated embodiments of FIGS. 1-12, a conical wall 46 is located in the housing interior 40 distal to the hemispherical wall 42 and faces the hemispherical wall. In the illustrated embodiments, the conical wall 46 comprises a proximal end 48, a distal end 50 comprising an exit aperture 52 facing the apex 44. In the illustrated embodiments, the conical wall 46 tapers in decreasing width from the proximal end to the distal end. More particularly, in the illustrated embodiment, a conical liner plate 14 forms the conical wall 46 and is machined as part of the base plate 12 or affixed to the base plate 12 mechanically or welded to the base plate 12. FIG. 2 shows a top view of the round pulse detonation wave generator 8 as depicted in FIG. 1.

In the illustrated embodiments of FIGS. 1-12, a channel 54 is located adjacent to the exit aperture 52 and in gaseous communication with the detonation chamber 10. The channel 54 may include a proximal end 56, a distal end 58, a length that extends from the proximal end to the distal end and that may be a parallel to the housing length 36, and an interior that may be hollow.

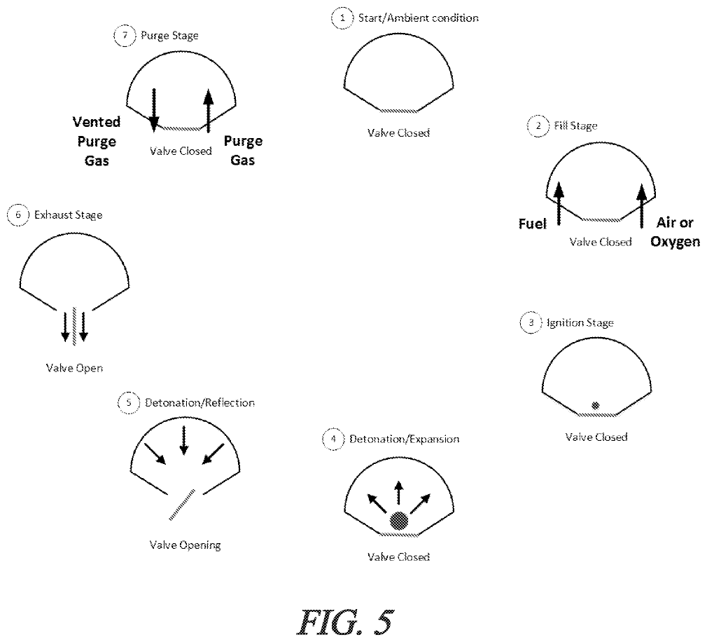

In the illustrated embodiments of FIGS. 1-12, distal to the base plate 12 is a chamber sealing valve 24 which seals the housing interior (and the hence the hemispherical detonation chamber 10) during filling, ignition, detonation, and purging operations. In the preferred embodiment, the hemispherical detonation chamber 10 is sealed by closing the chamber sealing valve 24. FIG. 5 shows a schematic of the full operational cycle. More particularly, the sealing valve 24 may be located adjacent the distal end of the channel, and the sealing valve 24 may have a closed position in which a detonation wave exiting the detonation chamber 10 via the exit aperture and passing along the channel is unable to exit the housing and an open position in which a detonation wave exiting the detonation chamber 10 via the exit aperture 52 and passing along the channel 54 is able to exit the housing.

In a preferred embodiment, the chamber sealing valve 24 is a fast-acting ¼ turn, 360 degree rotation ball valve that uses metal seats due to the high temperature gas travelling at supersonic speeds. The valve may be driven by an actuator (not shown) which can be pneumatic, hydraulic or electrical solenoid activated, depending on the application. Other valve types are also possible, such as rotary, flapper or electrically activated solenoid.

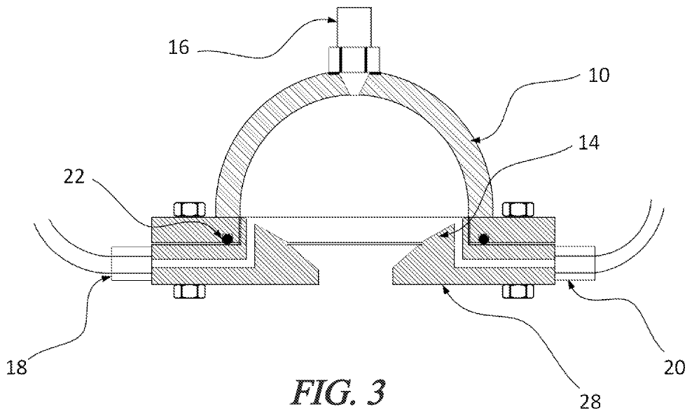

In an alternate embodiment, the hemispherical detonation chamber 10 is not mechanically sealed at all and the reactants are injected and ignited without mechanically sealing the hemispherical detonation chamber 10. In this embodiment, the injection sequence should be precisely controlled and timed to ensure reliable detonation of the reactants. FIG. 3 shows a cross-sectional view of a valveless embodiment.

In the preferred embodiment, performance optimization requires active computerized control of the detonation cycle which occurs at very high frequencies and over a wide range of conditions. For example, a practical Pulse Detonation Engine should operate between 50 to 100 Hz. A combination of sensors and one or more microprocessor controllers may be used to monitor the entire operating sequence and control/optimize functions such as fuel mixture ratio, ignition timing and valve opening and closing. The monitoring system preferably monitors and controls performance parameters such as detonation frequency, detonation pressure, temperature and fuel consumption, for example, and makes adjustments to ensure maximum performance. Those skilled in the art will recognize that the necessary control system may be similar to those used in jet engines and liquid propellant rocket engines, for example.

The hemispherical detonation chamber 10 may be filled with a mixture of reactants—e.g., fuel from a fuel injection injector and air or oxygen from an air or oxygen injection injector. The reactants may be introduced into the hemispherical detonation chamber 10 through one or more injectors—e.g., one or more fuel injectors 18 and one or more air or oxygen injectors 20. The injectors may be controlled by valves. The one or more injectors may be configured to inject one or more reactants into the housing interior (e.g., the channel in the illustrated embodiment) to allow the reactants to enter the detonation chamber and be ignited/detonated by the laser igniter (described below) to form a detonation wave. At very high velocities for in-atmosphere vehicles, compressed air from an inlet air duct can be used and controlled by a valve.

For embodiments using liquid reactants, the hemispherical detonation chamber 10 may be supplied with the reactants through liquid fuel and/or liquid oxidizer injectors.

In the preferred embodiment, the reactants are injected under pressure. Higher pressures are preferred in the hemispherical detonation chamber 10 since they produce higher velocity detonation waves.

The preferred embodiment for reactants is a gaseous, hydrogen/air or oxygen mixture due to its wide range of detonatable mixture ratios and the amount of energy released. However, many different fuels and fuel mixtures can be used by the device. These include, but are not limited to, methane, propane, acetylene, vaporized metals such as magnesium or aluminum, carbon based fuels and simple hydrocarbons that are highly atomized or vaporized. Stoichiometric mixtures are preferred since they produce higher velocity detonation waves.

In alternate embodiments, off-stoichiometric mixtures may be used depending on the reactants and their detonation characteristics or applications where reduced operating temperatures may be required.

The fuel used can be generated by a solid fuel gas generator to burn or pyrolize a solid fuel grain and generate a fuel rich gas mixture which may be metered by a control valve into the hemispherical detonation chamber 10 through the fuel injector 18.

The oxidizer can also be generated by a solid fuel oxygen generator to create oxygen. This embodiment works by igniting a solid compound such as lithium perchlorate within a canister. The oxygen rich gas may then metered by a control valve into the hemispherical detonation chamber 10 through the air or oxygen injector 20.

Some embodiments can use a combination of fuels. For example, the device could use a solid fuel generator and a liquid oxidizer at launch where the airspeed is low and then transition to a liquid or gaseous fuel and air for sustained operation once sufficient velocity has been achieved.

For devices that operate within the earth's atmosphere, the preferred embodiment uses air since it is readily available and because of its ability to support detonations with various fuels. For devices that operate as a pulse detonation rocket engine, the choice of oxidizer can be a liquid oxidizer such as liquid oxygen, nitrous oxide or concentrated hydrogen peroxide, for example. In the preferred embodiment, the liquid oxidizer will be converted into a gas, vaporized, or highly atomized to promote rapid detonation.

The hemispherical detonation chamber 10 can include atomizer modules to atomize a liquid fuel, or liquid oxidizer prior to introduction into the combustor. Alternatively, the hemispherical detonation chamber 10 can include vaporizer modules to vaporize a liquid fuel or liquid oxidizer.

In the preferred embodiment, the fuel and air/oxygen reactants are injected with a specific amount of turbulence to achieve rapid and thorough mixing of the reactants. The turbulence can be created with a turbulence generator such as a perforated disk or a swirler in the injection ports.

This turbulence facilitates the rapid mixing of the reactants and provides for optimal detonation characteristics.

The injected reactants may then be ignited by a laser igniter 16 which may be located at the apex and may be configured to direct a laser beam into the detonation chamber. In the preferred embodiment, the laser igniter is a passively Q-switched laser but may be another type of laser aimed at the geometric center of the base of the hemisphere which ignites the mixture, producing a symmetrical detonation wave.

In order to reliably produce a well-formed spherical detonation wave, a large amount of energy should be released very rapidly into the reactants and the initiation point should be located precisely to produce a symmetrical detonation wave.

In the preferred embodiment, a passively Q-switched laser igniter 16 provides the necessary energy for rapid, reliable ignition within several hundred nanoseconds and provides the ability to precisely position the ignition at the geometric center of the base of the hemisphere necessary for generating perfectly symmetrical shock waves. Those skilled in the art will recognize that other types of high energy igniters can also be utilized by the device.

The passively Q-switched laser igniter 16 generates a very high temperature light-emitting plasma which, when it cools down emits a pressure wave that propagates at supersonic speeds and ignites the fuel/air or oxygen mixture around the plasma core. This ensures a rapid and reliable detonation wave to be generated for each cycle of the device.

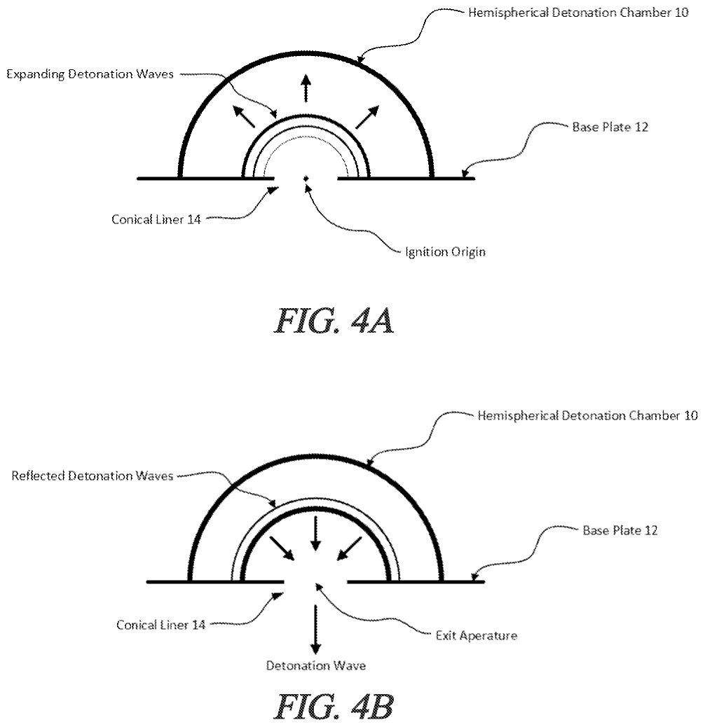

The resulting detonation wave then expands and impacts the hemispherical wall of the hemispherical detonation chamber 10 causing the detonation wave to be reflected towards the conical liner plate 14 and the exit aperture 52 in the base plate 12. See FIG. 4A and FIG. 4B for a schematic illustrating the principle of operation.

The conical liner plate 14 focuses the supersonic detonation wave and prevents extreme off-center shock waves which could damage the device. In one embodiment, the conical liner plate 14 is a separate component and is welded or mechanically attached to the base plate 12. In another embodiment, the conical liner plate 14 is machined as part of the base plate 12.

The conical liner plate 14 is preferably tapered at an angle to optimize and focus the detonation/shock wave as it leaves the hemispherical detonation chamber 10. The conical liner plate 14 and base plate 12 entrance geometry are preferably tapered to achieve the optimum shock wave for the fuel and air or oxygen mixture being used. In different embodiments, the angle of the conical liner plate angle 14 may vary with different fuel/air or oxygen combinations and/or pressures. In some embodiments, the angle may be between about 1 degree and about 20 degrees. However, the angle may vary depending on the application.

Once the detonation wave is initiated, the chamber sealing valve 24 is preferably opened rapidly, allowing the fully formed detonation wave traveling out of the exit aperture 52 and channel 54 to exit the housing interior 40 via exhaust aperture, which may be adjacent to the channel distal end 58 (and downstream from the sealing valve 24). In the preferred embodiment, the timing of the opening and closing of the chamber sealing valve 24 is important and should be computer controlled to precisely open and close at the exact moment. One or more sensors within the hemispherical detonation chamber 10 can be used to detect when the chamber sealing valve 24 is to be opened and closed. In an alternate embodiment, the opening of the chamber sealing valve 24 is controlled based on a timed offset of the laser igniter 16 firing to ignite the reactants. A combination of sensors and timing may also be implemented to control the device.

In an alternative embodiment where no chamber sealing valve 24 is present, the sensors simply control the injection of reactants, ignition and purge functions.

The chamber sealing valve 24 may be attached to the attachment plate 28 mechanically with bolts and an O-ring 22 may provide a gas seal between the sealing valve 24 and the attachment plate 28. In an alternate embodiment, a high temperature crush gasket, such as a mica gasket can be used to ensure a tight seat

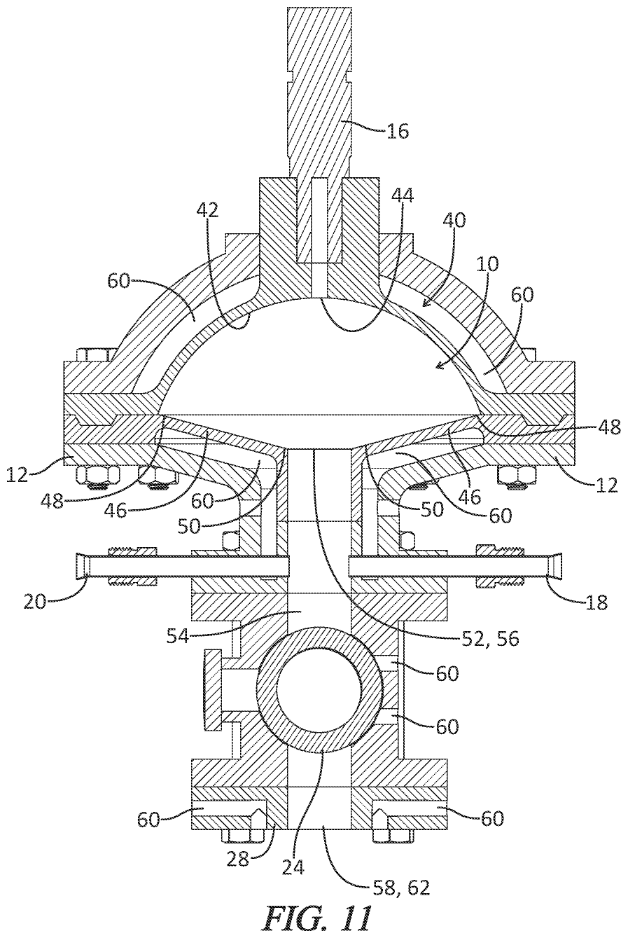

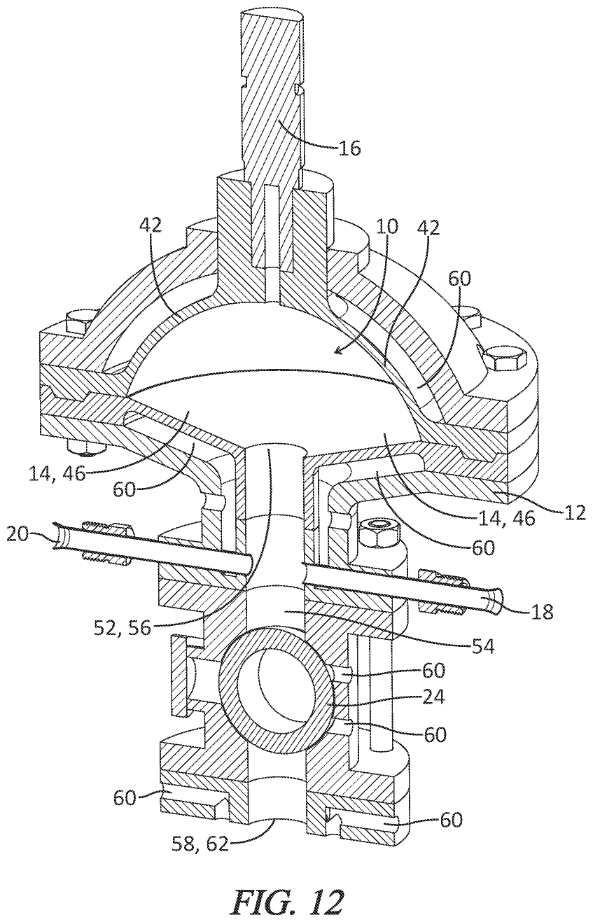

Due to the high temperatures resulting from the pulsed detonations, cooling of the device should be used for sustained operation. Both gaseous and/or liquid coolants can be used. In one embodiment, as best seen in FIGS. 11-12, a coolant chamber (such as a coolant jacket that receives/holds coolant) is exterior to the hemispherical detonation chamber and at least partially surrounds/lines the hemispherical detonation chamber 10 (e.g., the hemispherical wall and/or the conical wall) and/or the base plate 12 and any other areas of the device with high heat loads in order to provide active cooling to the device during operation due to the high operating temperature of the device. Optionally, as best seen in FIGS. 11-12, the sealing valve 24 is also cooled by a coolant. Optionally, as best seen in FIGS. 11-12, the coolant chamber 60 at least partially surrounds/lines one or more walls of the channel 54.

In some embodiments, the coolant chamber 60 comprises coolant channels machined into individual components allowing coolant passages in areas that cannot be protected by the coolant jacket.

In another embodiment, the coolant chamber 60 comprises a coolant tube carrying coolant may also be wrapped around components that require cooling.

In another embodiment, the coolant chamber 60 comprises a combination of coolant jackets, coolant channels and/or coolant tubes to allow for optimal cooling for each component.

The coolant used by the device can be a liquid or gas or a combination thereof, depending upon the application.

In the preferred embodiment, the coolant is optimally the fuel used in the hemispherical detonation chamber 10. In this embodiment, preheating the fuel prior to being injected into the hemispherical detonation chamber 10 results in greater fuel efficiency since the fuel temperature is raised prior to injection.

For very low duration or single use embodiments, no cooling may be required since the life span of the device is limited to seconds or less and the operation of the device will not exceed the ability of the materials selected to withstand the high pressures and temperatures generated. In this embodiment, a high temperature resistant alloy or other material may be used or a combination of active and passive cooling may be used where required by the application.

In the preferred embodiment, after each detonation in the hemispherical detonation chamber 10, the hemispherical detonation chamber 10 is purged of combustion products in preparation for the next detonation to prevent premature ignition of the injected reactants and to ensure only pure, unburned reactants fill the chamber.

For air-breathing embodiments where compressed air is available, such as Pulse Detonation Engines (PDE), the hemispherical detonation chamber 10 can be purged after by introducing purge air through an air inlet and exhausted through an exhaust port. The introduction and exhausting of the purge medium may be controlled by solenoid valves. In another embodiment, purge air is available from the compressor section of a turbine.

For non-air breathing embodiments such as Pulse Detonation Rocket Engines (PDRE), the chamber can be purged after by introducing purge fuel or oxidizer through a purge inlet and exhausted through an exhaust port. The introduction and exhausting of the purge medium may be controlled by solenoid valves.

Materials of construction for the device must be selected based on extreme operating conditions. Components of the device will be required to operate at very high temperatures and intermittent peak pressures on the order of at least 20 to 40 atmospheres and in some cases, much higher.

The hemispherical wall, conical liner plate 14, base plate 12, chamber sealing valve 24 and other parts of the device can be constructed of aerospace grade high strength alloys such as hastelloy, inconel, titanium, or other alloys such as titanium-zirconium-molybdenum.

The hemispherical wall, conical liner plate 14, base plate 12, and other parts of the device can be constructed of composite materials such as machined carbon/carbon. Where composite materials are used for the hemispherical wall or any other components subject to detonation gases, a coating of a suitable material may be applied to the surface of the carbon/carbon matrix to protect it from the high heat and detonation pressures generated within the device as well as the intermittent cycling.

It will be appreciated by those skilled in the art that ongoing development of new alloys and materials will undoubtedly produce new materials that will be suitable as well.

The components for the device can be manufactured using additive manufacturing, such as 3D printing or more traditional subtractive manufacturing techniques such as CNC machining, for example. This flexibility gives the designer considerable options when incorporating complex components such as coolant chambers into the device.

The present invention has many uses due to its compact size and its ability to reliably and consistently generate pulse detonation waves. The device is designed to allow different attachments can be mated to the device, depending on the application. The attachments are connected to the device by an attachment plate 28 that is attached to the device through spacers 26 that align the attachment to the device and transfer loads between the components.

The device can be used as a single pulse detonation wave generator 8 or in conjunction with multiple pulse detonation wave generators.

An embodiment is as a pre-detonator for a main combustion tube for air breathing pulse detonation engines (PDE's) or for pulse detonation rocket engines (PDRE's).

Another embodiment is as a stand-alone intermittent combustor with a DeLaval nozzle attachment for use as a thruster.

Another embodiment is a nozzle attachment for industrial cleaning or descaling hard to clean surfaces using the detonation wave energy.

Another embodiment is a sonic barrel attachment for an acoustical energy device such as a sound cannon.

Another embodiment is a barrel attachment for launching a projectile as a single shot device or a barrel and projectile feed mechanism attachment for multi-shot devices.

Another embodiment is a turbine attachment for generating electrical power. The hot gases, from the combustion chamber are expelled through a nozzle where they turn a turbine, which is used to generate electricity.

While the invention has been described in terms of various specific embodiments, those skilled in the art will recognize that the invention can be implemented with modification within the spirit and scope of the claims

The Pulse Detonation Generator cycle is a sequence of distinct events in the preferred embodiment: A. The hemispherical detonation chamber 10 is sealed by closing the chamber sealing valve 24. The chamber is at ambient conditions; B. The hemispherical detonation chamber 10 is filled with a fuel and air or oxygen mixture in the appropriate ratio for the reactants and with the appropriate turbulence; C. The laser igniter 16 fires and detonates the fuel/air or oxygen mixture; D. The detonation wave expands until it impacts the hemispherical detonation chamber 10 walls. E. The detonation wave is reflected back towards the hemispherical detonation chamber 10 exit aperture. The chamber sealing valve 24 is opened before the detonation wave reaches the exit aperture; F. The detonation wave exits the hemispherical detonation chamber 10 via exit aperture and the burned gases are exhausted out the exhaust aperture in housing; G. The chamber sealing valve 24 is closed and the hemispherical detonation chamber 10 is purged, depending on the application; and the cycle is repeated multiple times to produce a high frequency of pulse detonations.

Part List

| | |
|---|---|
| Pulse Detonation Wave Generator | 8 |
| Detonation Chamber | 10 |
| Base Plate | 12 |
| Conical Liner Plate | 14 |
| Laser Igniter | 16 |
| Fuel Injector | 18 |
| Oxygen Injector | 20 |
| O-ring | 22 |
| Sealing Valve | 24 |
| Spacer | 26 |
| Attachment Plate | 28 |
| Pulse wave generator housing | 30 |
| Housing proximal end | 32 |
| Housing distal end | 34 |
| Housing length | 36 |
| Housing width | 38 |
| Housing interior | 40 |
| Hemispherical wall | 42 |
| Hemispherical wall apex | 44 |
| Conical wall | 46 |
| Conical wall proximal end | 48 |
| Conical wall distal end | 50 |
| Exit aperture | 52 |
| Channel | 54 |
| Channel proximal end | 56 |
| Channel distal end | 58 |
| Coolant chambers | 60 |
| Exhaust aperture | 62 |

Having now described the invention in accordance with the requirements of the patent statutes, those skilled in the art will understand how to make changes and modifications to the disclosed embodiments to meet their specific requirements or conditions. Changes and modifications may be made without departing from the scope and spirit of the invention. In addition, the steps of any method described herein may be performed in any suitable order and steps may be performed simultaneously if needed. Use of the singular embraces the plural.

Terms of degree such as “generally”, “substantially”, “about”, and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

What is claimed is:

1. A pulse detonation wave generator comprising:
a housing comprising a proximal end, a distal end, a length extending from the proximal end to the distal end, a width perpendicular to the length, and an interior;
a hemispherical wall located in the housing interior and comprising an apex;
a conical wall located in the housing interior distal to the hemispherical wall and facing the hemispherical wall, the conical wall comprising a proximal end, a distal end comprising an exit aperture facing the apex, the conical wall tapering in decreasing width from the proximal end to the distal end, the hemispherical wall and the conical wall defining a detonation chamber;
a laser igniter located at the apex and configured to direct a laser beam into the detonation chamber;
a channel located adjacent to the exit aperture and in gaseous communication with the detonation chamber, the channel comprising a proximal end and a distal end;
one or more injectors configured to inject one or more reactants into the housing interior to allow the reactants to enter the detonation chamber and be ignited/detonated by the laser igniter to form a detonation wave;
a coolant chamber at least partially surrounding/lining an exterior of the hemispherical wall and/or the conical wall, the coolant chamber configured to receive coolant to cool the detonation chamber; and
a sealing valve located distal to the proximal end of the channel, the sealing valve having a closed position in which a detonation wave exiting the detonation chamber via the exit aperture and passing distally along the channel is unable to exit the housing and an open position in which a detonation wave exiting the detonation chamber via the exit aperture and passing distally along the channel is able to exit the housing.

2. The pulse detonation wave generator of claim 1 wherein the sealing valve is a 360 degree rotation ball valve.

3. The pulse detonation wave generator of claim 1 wherein the sealing valve is cooled by gas or liquid.

4. The pulse detonation wave generator of claim 1 wherein the exit aperture forms the proximal end of the channel.

5. The pulse detonation wave generator of claim 1 further comprising a sensor configured to control opening and closing of the sealing valve.

6. The pulse detonation wave generator of claim 1 wherein the coolant chamber at least partially surrounds/lines one or more walls of the channel.

7. The pulse detonation wave generator of claim 1 wherein the hemispherical wall is located adjacent the housing proximal end.

8. The pulse detonation wave generator of claim 1 wherein the one or more injectors are controlled by one or more injector valves.

9. The pulse detonation wave generator of claim 1 wherein the housing further comprises an exhaust aperture in gaseous communication with the channel and downstream from the sealing valve.

10. The pulse detonation wave generator of claim 1 wherein the exhaust aperture is located at the distal end of the channel.

11. A method of generating a detonation wave comprising:
a) providing the pulse detonation wave generator of claim 1 wherein the sealing valve is in the closed position;
b) using the one or more injectors to inject one or more reactants into the housing interior to allow the reactants to enter the detonation chamber;
c) using the laser igniter to direct light/a laser beam into the detonation chamber to denotate the one or more reactants to form a detonation wave;
d) reflecting the detonation wave against the hemispherical wall and then towards the conical wall; and
e) allowing the detonation wave to move out the exit aperture and distally along the channel.

12. The method of claim 11 wherein the method further comprises moving the sealing valve from the closed position to the open position prior to step e).

13. The method of claim 12 wherein the method further comprises moving the sealing valve from the open position to the closed position after step e).

14. The method of claim 11 wherein the exit aperture comprises a center and wherein the direct light/a laser beam of the laser igniter is centered on the center of the exit aperture in step c).

15. The method of claim 11 wherein the method further comprises flowing a coolant around the coolant chamber to cool the detonation chamber between steps c) and e).

16. The method of claim 11 wherein the method further comprises flowing a coolant around the sealing valve to cool the sealing valve between steps c) and e).

17. The method of claim 16 further comprising repeating steps b) through e) in a plurality of cycles to produce a plurality of detonation waves while flowing a coolant around the coolant chamber to cool the detonation chamber and/or while flowing a coolant around the sealing valve to cool the sealing valve.

18. The method of claim 17 wherein each cycle further comprises moving the sealing valve from the closed position to the open position prior to step e).

19. The method of claim 18 wherein each cycle further comprises moving the sealing valve from the open position to the closed position after step e).

20. The method of claim 11 wherein the method further comprises removing the detonated one or more reactants from the housing after step c).

21. The method of claim 11 wherein the housing further comprises an exhaust aperture in gaseous communication with the channel and the method further comprises flowing the detonated one or more reactants from the detonation chamber, through the channel and out the exhaust aperture after step c).

22. The method of claim 21 wherein the exhaust aperture is located at the distal end of the channel.

23. The method of claim 21 wherein the exhaust aperture is downstream from the sealing valve.
